(19) United States
(12) Patent Application Publication
(10) Pub. No.: US 2025/0381642 A1
(43) Pub. Date: Dec. 18, 2025

(54) WAFER GRINDING APPARATUS AND METHOD FOR PLACING AND RETRIEVING WAFERS

(71) Applicant: JOEN LIH MACHINERY CO., LTD., Taichung City (TW)

(72) Inventors: Hsin-Tang LIN, Taichung City (TW); Chih-Chieh LIN, Taichung City (TW)

(21) Appl. No.: 18/741,158

(22) Filed: Jun. 12, 2024

(51) Int. Cl. B24B 41/00; B24B 7/22; B25J 9/16; B25J 11/00

(52) U.S. Cl. CPC B24B 41/005; B24B 7/228; B25J 11/0065; B25J 9/1653; B25J 9/1679; B25J 9/1697

(57) ABSTRACT

Disclosed is awafer grinding apparatus and a method for placing and retrieving wafers. The wafer grinding apparatus has several wafer turntables, a driving device, a grinding device, a front table, a rear table, a transfer device, and a control unit. Each wafer turntable features several positioning holes for locating wafers and forms an identification mark for distinguishing and identifying each wafer turntable, a first positioning mark for identifying the placement center of the positioning holes, and a hole position mark for identifying each positioning hole. The wafer grinding apparatus also binds the corresponding identification mark and hole position mark of the wafer to form a grinding record that facilitates tracking the processing history of the wafer.

### CROSS-REFERENCE TO RELATED APPLICATIONS

Not applicable.

### BACKGROUND OF THE INVENTION

The present invention relates to a component used in the wafer grinding process, specifically a wafer grinding apparatus and a method for placing and retrieving wafers.

A wafer grinding apparatus comprises several wafer turntables, a driving device, a grinding device, and a transfer device. The wafer turntables are spaced apart on the driving device, which drives each wafer turntable to operate in a cycle. Each wafer turntable is pierced with multiple positioning holes to hold multiple wafers. The grinding device processes each wafer, and the transfer device relocates each wafer to its respective positioning hole and removes it from the wafer turntable upon completion of the grinding process.

The transfer device comprises a placement unit, a processing unit, and a robotic arm that individually places multiple wafers in different positioning holes.

Upon completion of the grinding process, the transfer device individually transfers the multiple processed wafers out of the grinding process.

In the absence of a record of the processing history of each wafer, i.e., the grinding process of the wafer, which is required to record not only the length of time the wafer is ground, but also the wafer turntable and the positioning holes in which the wafer is positioned, the transfer device is unable to identify the wafer turntable and the positioning holes in which the wafer is transferred, which is not conducive to tracking the processing history of each wafer.

### SUMMARY OF THE INVENTION

The main purpose of the present invention is to provide a wafer grinding apparatus and a method for placing and retrieving wafers.

In order to achieve the above purpose, the present invention employs the following technical solution:

A wafer grinding apparatus, comprising several wafer turntables, a driving device, a grinding device, a front table, a rear table, a transfer device, and a control unit, wherein each wafer turntable is intermittently arranged on the driving device and is equidistantly pierced with several positioning holes for placing wafers, and the grinding device which is set on the top of a driving device, is used to grind each of the wafers.

Each wafer turntable forms an identification mark for distinguishing and identifying the wafer turntable, a first positioning mark for identifying the placement center of the positioning holes, and several hole position marks in the vicinity of each positioning hole for identifying each positioning hole.

The front table forms at least a first placement structure for placing wafers to be ground.

The rear table forms at least a second placement structure for placing ground wafers.

The transfer device comprises a placement unit and a robotic arm, the placement unit being mounted at the working end of the robotic arm. The placement unit comprises a mount, a lifter, a suction cup module, and an image capture device, wherein the mount is connected to the robotic arm, the lifter is connected to the mount, and the suction cup module is connected to the lifter, enabling the lifter to raise and lower the suction cup module toward or away from a selected wafer. The suction cup module comprises at least one vacuum suction cup for sucking and releasing the wafer. The image capture device, which is attached on the mount, is used to capture images.

The control unit, which is mainly composed of electronic circuits, includes a programmable controller, a storage medium, and a microprocessor, wherein the programmable controller and the storage medium are electrically connected to the microprocessor, respectively. The programmable controller is electrically connected to the placement unit and the robotic arm. The storage medium is a readable and writable memory medium used to store the grinding records of the wafers and the microprocessor is electrically connected to the image capture device.

The microprocessor executes an image recognition program to identify the images captured by the image capture device and controls the robotic arm and the placement unit through the programmable controller based on the identification results to allow the placement or retrieval of the wafers. The microprocessor also binds the identity identification code of the wafer with the corresponding identification mark and the hole position mark to form the grinding record for the respective wafer.

A method for placing and retrieving wafers, which is performed using the wafer grinding apparatus according to claim 1, comprising the following steps:

Retrieving wafer by placement unit: the robotic arm moves the placement unit to the above space of the front table, the control unit, based on the result of identifying the image captured by the image capture device, controls the transfer device to calibrate the suction cup module to align with the wafer to be ground that is pre-positioned in the first placement structure, then the suction cup module sucks the wafer.

Aligning placement unit with wafer turntable: the robotic arm moves the placement unit to the above space of a selected wafer turntable, and the control unit controls the transfer device, based on the result of identifying the image captured by the image capture device, to align the suction cup module with a selected positioning hole using the first positioning mark as a reference point; the control unit records the identification mark of the wafer turntable and the hole position mark of the positioning hole corresponding to the wafer.

Placing wafer by placement unit: the suction cup module releases the wafer into the corresponding positioning hole so that the driving device and the grinding device are operated to complete the grinding process of the wafer.

Aligning placement unit with wafer: after the grinding process is completed, the robotic arm moves the placement unit to the above space of the selected wafer turntable, and the control unit controls the transfer device to calibrate the suction cup module to align with a selected ground wafer based on the result of identifying the images captured by the image capture device, and the control unit records the identification mark of the wafer turntable and the hole position mark of the positioning hole corresponding to the wafer.

Transferring wafer by transfer device: the suction cup module sucks the wafer and lifts the wafer away from the wafer turntable, then the robotic arm moves the placement unit above the rear table; the control unit, based on the result of identifying the image captured by the image capture device, controls the transfer device to calibrate the suction cup module to align with the second placement structure, and the placement unit releases the ground wafer onto the second placement structure.

Storing grinding records: the microprocessor binds the identity identification code of the wafer with the corresponding identification mark and the hole position mark to form the grinding record for the respective wafer, which is stored in the storage medium.

The present invention is capable of recording the identification mark of the wafer turntable and the hole position mark corresponding to the positioning holes where is the wafer is placed, together with the binding of the identity identification code of the wafer to form the grinding record, which is advantageous for tracking the processing history of each wafer.

### BRIEF DESCRIPTION OF DRAWINGS

FIG. 1 is a schematic perspective view of part of the wafer grinding apparatus in Embodiment 1 of the present invention.

FIG. 2 is a top view of part of the wafer grinding apparatus in Embodiment 1.

FIG. 3 is an enlarged view of part of FIG. 2.

FIG. 4. is another enlarged view of part of FIG. 2.

FIG. 5. is another enlarged view of part of FIG. 2.

FIG. 6. is a perspective view of part of the wafer grinding apparatus in Embodiment 1.

FIG. 7. is a circuit block diagram of the transfer device in Embodiment 1.

FIG. 8 is a flowchart of the method for placing and retrieving wafers in Embodiment 1.

FIG. 9 is a perspective view of the wafer grinding apparatus placing wafers onto the wafer turntable in Embodiment 1.

FIG. 10 is a perspective view of part of the wafer grinding apparatus in Embodiment 2.

FIG. 11 is an enlarged top view of part of the wafer turntable in Embodiment 3.

### DETAILED DESCRIPTION OF THE INVENTION

Please refer to the drawings for a preferred embodiment of the present invention, but these embodiments are for illustrative purposes only and are not subject to the limitations of this structure for patent application.

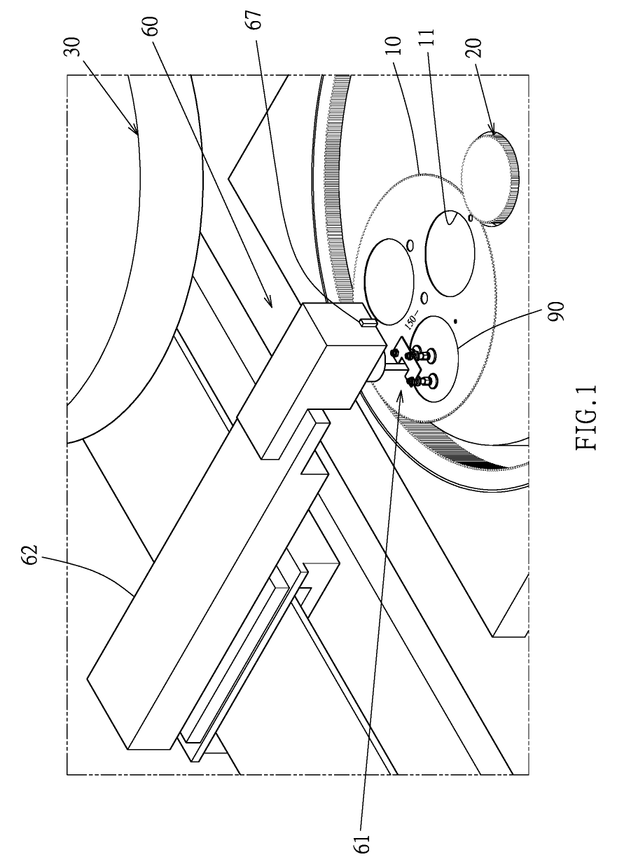

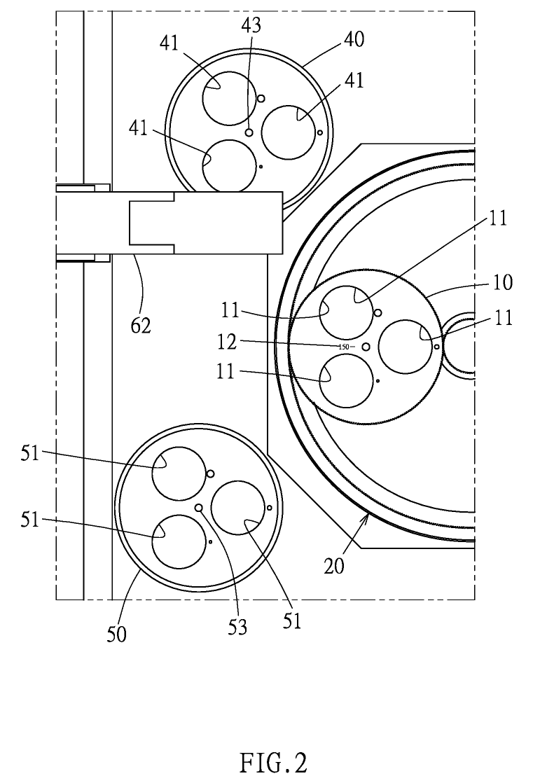

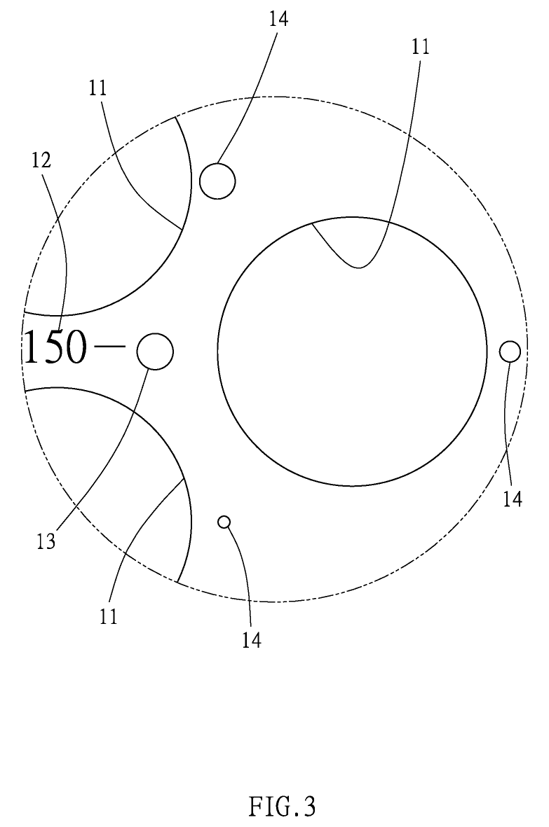

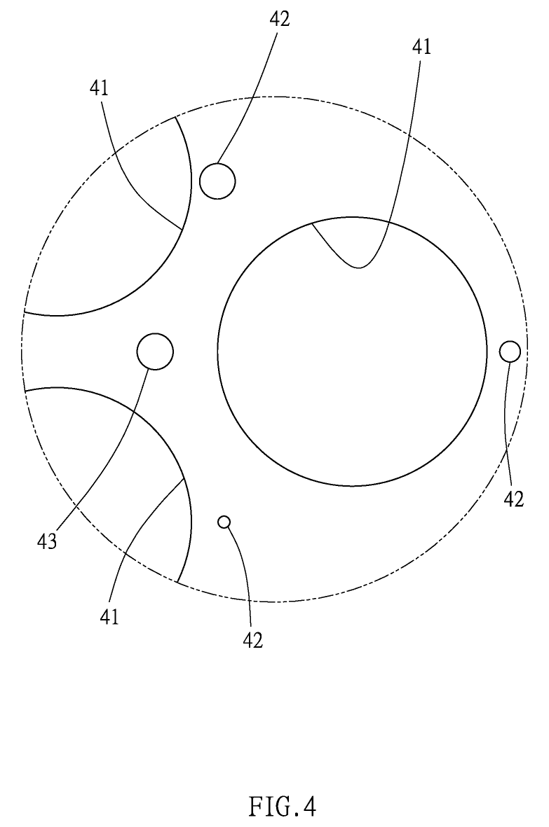

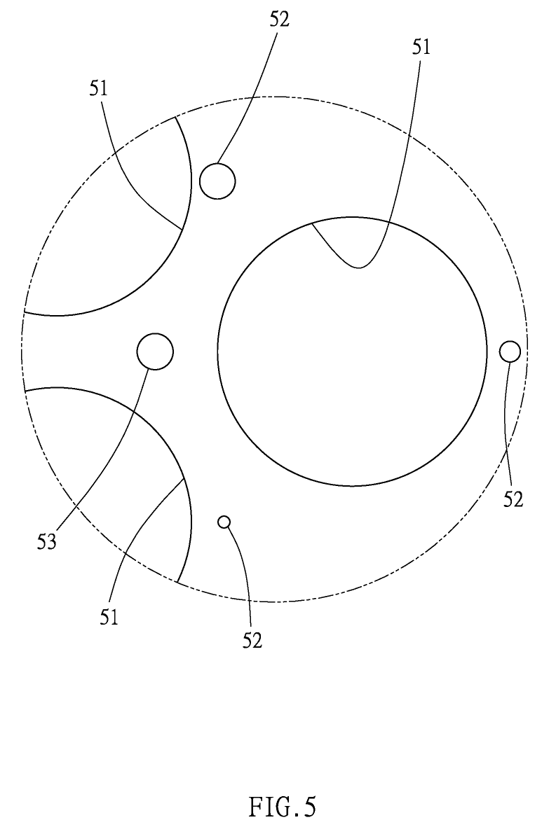

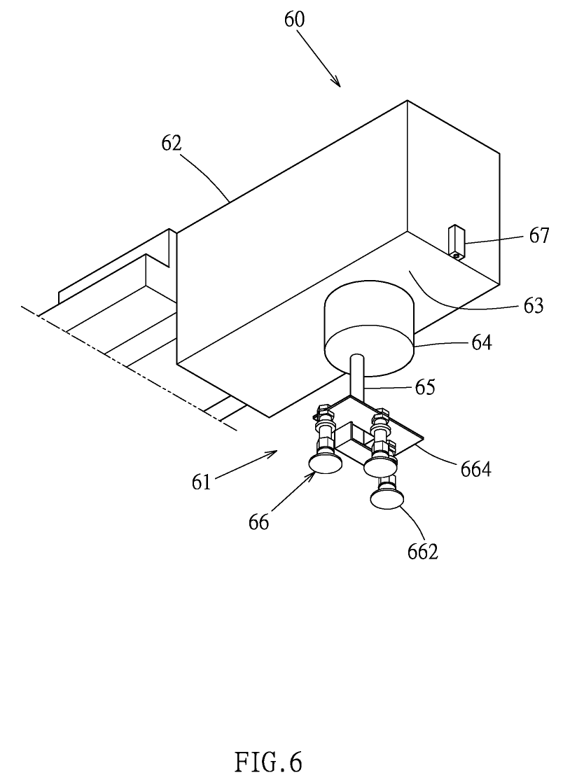

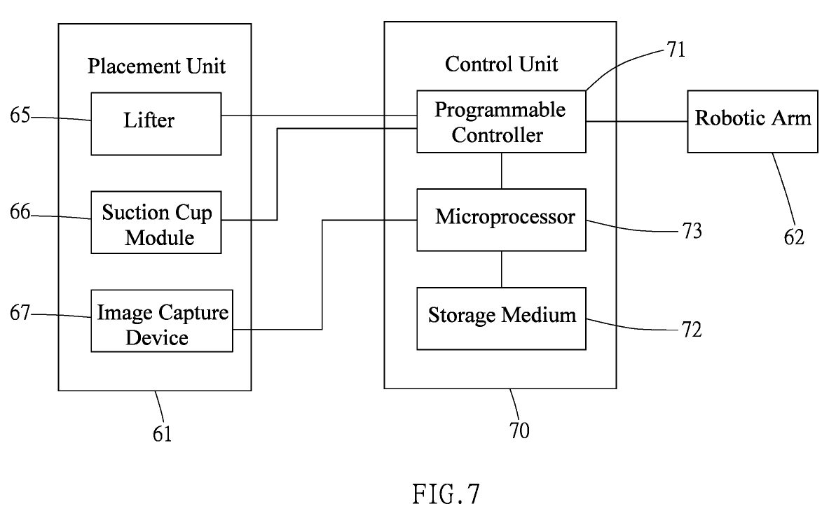

As shown in FIGS. 1 through 7, a wafer grinding apparatus comprises several wafer turntables 10, a driving device 20, a grinding device 30, a front table 40, a rear table 50, a transfer device 60, and a control unit 70. Each wafer turntable 10 is intermittently arranged on the driving device 20. The driving device 20 is used to cyclically operate each wafer turntable 10, which rotates simultaneously during operation. Each wafer turntable 10 is pierced with several positioning holes 11, which are arranged equidistantly in this embodiment, each for placing and positioning a wafer 90. The grinding device 30 which is set on the top of a driving device, is used to grind the wafers 90 placed on each wafer turntable 10. Since the specifics of the driving device 20 and the grinding device 30 are well-known to those skilled in the art and are not necessarily related to the technical characteristics of the present invention, detailed descriptions will be omitted.

Each wafer turntable 10 forms an identification mark 12 to distinguish and identify each wafer turntable, and a first positioning mark 13 to identify the placement center of the positioning holes 11. In this embodiment, each first positioning mark 13 is located at the radial center of each wafer turntable 10, with the positioning holes 11 arranged around the first positioning mark 13. Several hole position marks 14 are formed in the vicinity of each positioning hole 11 for distinguishing and identifying those positioning holes 11.

The identification mark 12, the first positioning mark 13, and the hole position mark 14 may be numbers, text, graphics, or a combination thereof. Each wafer turntable 10 has a distinct identification mark 12, which in this embodiment is selected to be numbered, while the first positioning mark 13 and the hole position marks 14 are each selected to be the hole through the wafer turntable 10, and each hole position mark 14 is selected to be the hole with a different diameter.

The front table 40 intermittently forms several first placement structures 41 and first placement marks 42 in accordance with the number and arrangement of the positioning holes 11 of the wafer turntables 10 for placing the wafers 90 to be ground, and each first placement mark 42 is used to distinguish and identify each first placement structure 41. The front table 40 also forms a second positioning mark 43 for identifying the placement center of each first placement structures 41.

The number and arrangement of the first placement structures 41 are not limited by the number and arrangement of the positioning holes 11 and can be varied as needed. Accordingly, when the front table 40 chooses to form a single first placement structure 41, it chooses not to form the first placement mark 42 and the second positioning mark 43, while when multiple first placement structures 41 are formed, the front table 40 therefore chooses to form the first placement mark 42 and the second positioning mark 43.

The rear table 50 intermittently forms several second placement structures 51 in accordance with the number and arrangement of the positioning holes 11 of the wafer turntables 10 for placing the ground wafers 90. The rear table 50 forms a third positioning mark 53 for identifying the placement center of the second placement structure 51.

The number and arrangement of the second placement structure 51 are not limited by the number and arrangement of the positioning holes 11 and can be varied as needed. Accordingly, when the rear table 50 chooses to form a single second placement structure 51, it chooses not to form the second placement mark 52 and the third positioning mark 53, while when multiple second placement structures 51 are formed, the rear table 50 therefore chooses to form the second placement mark 52 and the third positioning mark 53.

The transfer device 60 is used to transfer the wafers 90 between the front table 40, the wafer turntables 10, and the rear table 50. It comprises a placement unit 61 and a robotic arm 62. The placement unit 61 is mounted at the working end 63 of the robotic arm 62, which maneuvers the placement unit 61 toward or away from a selected wafer turntable 10.

The placement unit 61 comprises a mount 64, a lifter 65, a suction cup module 66, and an image capture device 67. The mount 64 is connected to the robotic arm 62, the lifter 65 is connected to the mount 64, and the suction cup module 66 is connected to the lifter 65, enabling the lifter 65 to raise and lower the suction cup module 66 toward or away from a selected wafer 90. The suction cup module 66 comprises three vacuum suction cups 662 for sucking and releasing the wafer 90, with the number of vacuum suction cups 662 in each suction cup module 66 varying as needed, provided that each suction cup module 66 has at least one vacuum suction cup 662.

The image capture device 67, which is attached on the mount 64, is used to capture images. In this embodiment, the image capture device 67 is a camera lens having a photosensitive element (not shown). Specific examples of the photosensitive element include Charge-coupled Device (CCD) and Complementary Metal-Oxide-Semiconductor (CMOS).

The control unit 70, which is mainly composed of electronic circuits, is optionally placed at a suitable position of the wafer grinding apparatus. It includes a programmable controller 71, a storage medium 72, and a microprocessor 73. The programmable controller 71 and the storage medium 72 are electrically connected to the microprocessor 73, respectively. Meanwhile, the programmable controller 71 is electrically connected to the placement unit 61 and the robotic arm 62. The storage medium 72 is a readable and writable memory medium used to store the grinding records of the wafers 90, and the microprocessor 73 is electrically connected to the image capture device 67.

The microprocessor 73 executes an image recognition program to identify the images captured by the image capture device 67. Based on the identification results, it controls the robotic arm 62 and the placement unit 61 through the programmable controller 71. This allows the wafers 90 to be placed in a selected positioning hole 11 of a selected wafer turntable 10 for grinding, and the ground wafers 90 to be removed from the selected positioning hole 11 of the selected wafer turntable 10. The microprocessor 73 also binds the identity identification code of the wafer 90 with the corresponding first placement mark 42, the identification mark 12, the hole position mark 14, and the second placement mark 52 to form the grinding record for the respective wafer 90.

In cases where the front table 40 does not have the first placement mark 42, the grinding records processed by the microprocessor 73 will also not include the first placement mark 42. Similarly, if the rear table 50 does not have the second placement mark 52, the grinding records processed by the microprocessor 73 will not include the second placement mark 52.

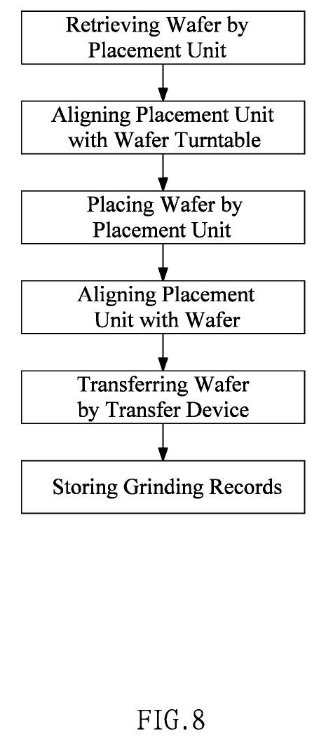

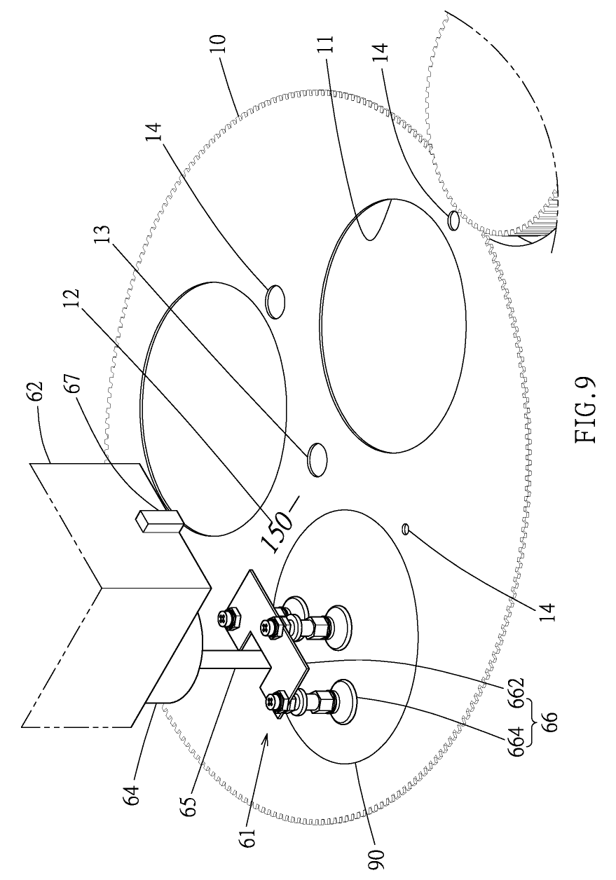

As shown in FIGS. 8 and 9, a method of placing and retrieving wafers using the aforementioned wafer grinding apparatus includes the following steps:

Retrieving wafer by placement unit: The robotic arm 62 moves the placement unit 61 to the above space of the front table 40. Based on the image result of the front table 40 captured by the image capture device 67, the control unit 70 calibrates the suction cup module 66 to align with a selected wafer 90 to be ground pre-positioned on the first placement structures 41. The microprocessor 73 records the corresponding first placement mark 42 of the first placement structure 41 on which the wafer 90 is placed. The control unit 70 then controls the vacuum suction cup 662 in the suction cup module 66 to suck the wafer 90 and records the corresponding first placement mark 42.

The process of aligning the suction cup module 66 with the selected wafer 90 by the transfer device 60 is mainly as follows: the robotic arm 62 moves so that the center of the placement unit 61 is aligned with the second positioning mark 43. The control unit 70 then controls the movement of the robotic arm 6, using the second positioning mark 43 as a reference point, to enable the placement unit 61 to move toward the top of the selected wafer 90. The control unit 70 controls the direction and amount of movement of the robotic arm 62 to align the suction cup module 66 with the wafer 90, based on the difference in alignment between the wafer 90 and the suction cup module 66.

In the case where the front table 40 chooses to form a single first placement structure 41 and does not have the second positioning mark 43 and the first placement mark 42, the control unit 70 controls the movement of the robotic arm 62 to enable the placement unit 61 to move toward the selected wafer 90. The control unit 70 controls the direction and the amount of movement of the robotic arm 62 to align the suction cup module 66 with the wafer 90, based on the difference in alignment between the wafer 90 and the suction cup module 66.

Aligning placement unit with wafer turntable: The robotic arm 62 moves the placement unit 61 to the above space of the selected wafer turntable 10. The image capture device 67 captures the image of the identification mark 12 of the wafer turntable 10, and the microprocessor 73 executes the image recognition program to identify and record the wafer turntable 10 on which the wafers 90 are placed. The image capture device 67 also captures the image of the first positioning mark 13 on the wafer turntable 10, based on which the microprocessor 73 calculates the axial distance deviation for positioning the placement unit 61 relative to the selected positioning hole 11. The control unit 70 controls the amount and direction of movement of the robotic arm 62, enabling the transfer device 60 to calibrate the suction cup module 66 for alignment with the selected positioning hole 11. The control unit 70 also records the identification mark 12 of the wafer turntable 10 and the hole position mark 14 of the corresponding positioning hole 11.

Placing wafer by placement unit: The control unit 70 controls the suction cup module 66 to release the wafer 90 into the positioning hole 11.

By repeating the steps of retrieving the wafer by the placement unit, aligning the placement unit with the wafer turntable, and placing the wafer by the placement unit as described, the multiple wafers 90 for grinding can be individually placed in each positioning hole 11 of each wafer turntable 10. As a result, the driving device 20 and the grinding device 30 can be operated to complete the grinding process for each wafer 90.

Aligning placement unit with wafer: After the grinding process is completed, the robotic arm 62 moves the placement unit 61 to the above space of the selected wafer turntable 10. Based on the image result of the wafer turntable 10 captured by the image capture device 67, the control unit 70 controls the transfer device 60 to calibrate the suction cup module 66 to align with the selected ground wafer 90, and the control unit 70 also records the identification mark 12 of the wafer turntable 10 and the hole position mark 14 of the corresponding positioning hole 11.

Transferring wafer by transfer device: The suction cup module 66 sucks the wafer 90, lifts the wafer 90 away from the wafer turntable 10, and the robotic arm 62 moves the placement unit 61 to the above of the rear table 50. Based on the images result captured by the image capture device 67, the control unit 70 controls the transfer device 60 to calibrate the suction cup module 66 to align with the second placement structure 51 on the rear table 50. The placement unit 61 then releases the ground wafer 90 onto the second placement structure 51. The control unit 70 also records the second placement mark 52 corresponding to the second placement structure 51 on which the wafer 90 is placed.

The process of aligning the suction cup module 66 with the second placement structure 51 by the transfer device 60 is mainly as follows: the robotic arm 62 moves so that the center of the placement unit 61 is aligned with the third positioning mark 53. The control unit 70 then controls the movement of the robotic arm 62, using the third positioning mark 53 as a reference point, to enable the placement unit 61 to move toward the above of the selected second placement structure 51. The control unit 70 controls the direction and amount of movement of the robotic arm 62 to align the suction cup module 66 with the second placement structure 51, based on the difference in alignment between the second placement structure 51 and the suction cup module 66.

Storing grinding records: The microprocessor 73 binds the identity identification code of the wafer 90 with the corresponding first placement mark 42, the identification mark 12, the hole position mark 14, and the second placement mark 52 to form the grinding record for the respective wafer 90, which is stored in the storage medium 72.

In cases where the front table 40 does not have the first placement mark 42, the grinding records processed by the microprocessor 73 will also not include the first placement mark 42. Similarly, if the rear table 50 does not have the second placement mark 52, the grinding records processed by the microprocessor 73 will not include the second placement mark 52.

During the process of placing the wafer 90 on the selected wafer turntable 10 and retrieving the wafer 90 from the wafer turntable 10, the transfer device 60 can identify the first placement structure 41, the wafer turntable 10, the positioning hole 11, and the second placement structure 51 on which each wafer 90 is placed, and record the corresponding first placement mark 42, the identification mark 12, the hole position mark 14, and the second placement mark 52 for each wafer 90 and associate them with the identity identification code of each wafer 90 to form the grinding record stored in the storage medium 72. This facilitates tracking the processing history of each wafer 90.

The suction cup module 66 further includes a positioning frame 664 on which each vacuum suction cup 662 is installed, and the lifter 65 is connected to this positioning frame 664.

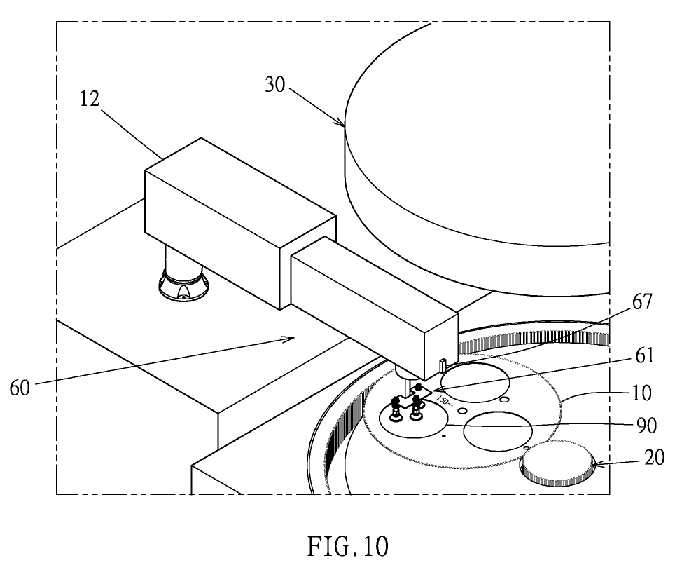

As shown in FIG. 10, Embodiment 2 differs from Embodiment 1 primarily in the type of robotic arm 62.

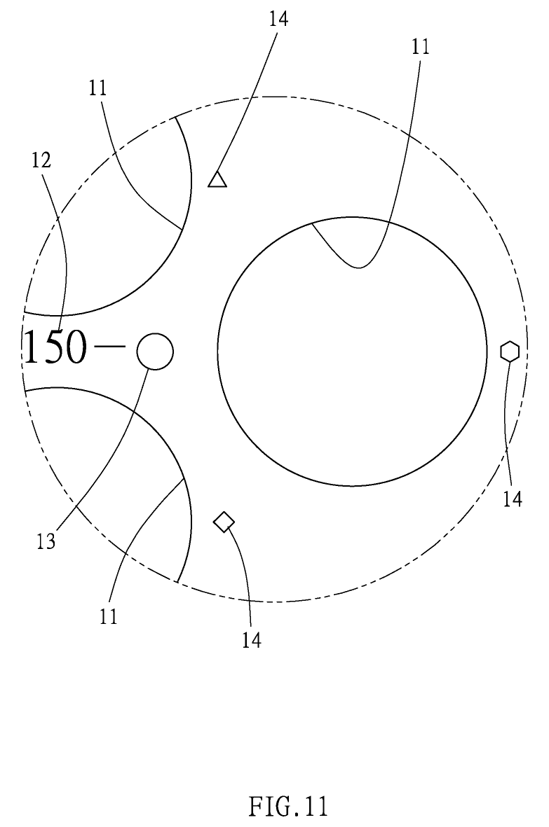

As shown in FIG. 11, Embodiment 3 primarily differs from Embodiment 1 in that each hole position mark 14 is a hole of a different shape.

1. A wafer grinding apparatus, comprising several wafer turntables, a driving device, a grinding device, a front table, a rear table, a transfer device, and a control unit, wherein each wafer turntable is intermittently arranged on the driving device and is equidistantly pierced with several positioning holes for placing wafers, and the grinding device which is set on the top of a driving device, is used to grind each of the wafers;
each wafer turntable forms an identification mark for distinguishing and identifying the wafer turntable, a first positioning mark for identifying the placement center of the positioning holes, and several hole position marks in the vicinity of each positioning hole for identifying each positioning hole;
the front table forms at least a first placement structure for placing wafers to be ground;
the rear table forms at least a second placement structure for placing ground wafers;
the transfer device comprises a placement unit and a robotic arm, the placement unit being mounted at the working end of the robotic arm; the placement unit comprises a mount, a lifter, a suction cup module, and an image capture device, wherein the mount is connected to the robotic arm, the lifter is connected to the mount, and the suction cup module is connected to the lifter, enabling the lifter to raise and lower the suction cup module toward or away from a selected wafer; the suction cup module comprises at least one vacuum suction cup for sucking and releasing the wafer; the image capture device, which is attached on the mount, is used to capture images;
the control unit, which is mainly composed of electronic circuits, includes a programmable controller, a storage medium, and a microprocessor, wherein the programmable controller and the storage medium are electrically connected to the microprocessor, respectively; the programmable controller is electrically connected to the placement unit and the robotic arm; the storage medium is a readable and writable memory medium used to store the grinding records of the wafers; and the microprocessor is electrically connected to the image capture device;
the microprocessor executes an image recognition program to identify the images captured by the image capture device and controls the robotic arm and the placement unit through the programmable controller based on the identification results to allow the placement or retrieval of the wafers; the microprocessor also binds the identity identification code of the wafer with the corresponding identification mark and the hole position mark to form the grinding record for the respective wafer.

2. The wafer grinding apparatus according to claim 1, wherein the front table intermittently forms several first placement structures and first placement marks in accordance with the number and arrangement of the positioning holes of the wafer turntables, and each first placement mark is used to distinguish and identify each first placement structure; the front table also forms a second positioning mark for identifying the placement center of the first placement structures;
the microprocessor binds the identity identification code of the wafer with the corresponding first placement mark, the identification mark, and the hole position mark to form multiple grinding records respective to each wafer.

3. The wafer grinding apparatus according to claim 1, wherein the rear table intermittently forms several second placement structures in accordance with the number and arrangement of the positioning holes of the wafer turntables, and the rear table also forms a third positioning mark for identifying the placement center of the second placement structure.

4. The wafer grinding apparatus according to claim 3, wherein the rear table forms several second placement marks, each for distinguishing and identifying the second placement structures;
the microprocessor binds the identity identification code of the wafer with the corresponding identification mark, the hole position mark, and the second placement mark to form multiple grinding records respective to each wafer.

5. A method for placing and retrieving wafers, which is performed using the wafer grinding apparatus according to claim 1, comprising the following steps:
retrieving wafer by placement unit: the robotic arm moves the placement unit to the above space of the front table, the control unit, based on the result of identifying the image captured by the image capture device, controls the transfer device to calibrate the suction cup module to align with the wafer to be ground that is pre-positioned in the first placement structure, then the suction cup module sucks the wafer;
aligning placement unit with wafer turntable: the robotic arm moves the placement unit to the above space of a selected wafer turntable, and the control unit controls the transfer device, based on the result of identifying the image captured by the image capture device, to align the suction cup module with a selected positioning hole using the first positioning mark as a reference point; the control unit records the identification mark of the wafer turntable and the hole position mark of the positioning hole corresponding to the wafer;
placing wafer by placement unit: the suction cup module releases the wafer into the corresponding positioning hole so that the driving device and the grinding device are operated to complete the grinding process of the wafer;
aligning placement unit with wafer: after the grinding process is completed, the robotic arm moves the placement unit to the above space of the selected wafer turntable, and the control unit controls the transfer device to calibrate the suction cup module to align with a selected ground wafer based on the result of identifying the images captured by the image capture device, and the control unit records the identification mark of the wafer turntable and the hole position mark of the positioning hole corresponding to the wafer;
transferring wafer by transfer device: the suction cup module sucks the wafer and lifts the wafer away from the wafer turntable, then the robotic arm moves the placement unit above the rear table; the control unit, based on the result of identifying the image captured by the image capture device, controls the transfer device to calibrate the suction cup module to align with the second placement structure, and the placement unit releases the ground wafer onto the second placement structure; and
storing grinding records: the microprocessor binds the identity identification code of the wafer with the corresponding identification mark and the hole position mark to form the grinding record for the respective wafer, which is stored in the storage medium.
